(19) United States
(12) Patent Application Publication
(10) Pub. No.: US 2010/0059650 A1
(43) Pub. Date: Mar. 11, 2010

(54) SUPPORT DEVICE

(75) Inventor: Takuji Kaneko, Osaka (JP)

Correspondence Address: OSHA LIANG L.L.P., TWO HOUSTON CENTER, 909 FANNIN, SUITE 3500, HOUSTON, TX, 77010, US

(73) Assignee: FUNAI ELECTRIC CO., LTD., Osaka (JP)

(21) Appl. No.: 12/537,781

(22) Filed: Aug. 7, 2009

(30) Foreign Application Priority Data
Aug. 7, 2008 (JP) 2008-204079

(51) Int. Cl. F16M 11/12

(52) U.S. Cl. 248/372.1; 248/371

(57) ABSTRACT

A first gear part is formed at one end of a second supporting rod. The first gear part is stored in a second storage part and a fourth storage part having gear-like projections for engaging the first gear part. Tightening condition between a first frame and a second frame is adjusted by a tightening knob to turn or fix an arm unit in a vertical direction. A second gear part is formed at the other end of the second supporting rod and engaged with a third gear part formed on a top surface of a main body of a base. Tightening condition between the second gear part and the third gear part is adjusted by a rotary knob to turn or fix the arm unit in a horizontal direction.

### TECHNICAL FIELD

The present invention relates to a support device for supporting an apparatus such as an image pickup device and a video display in any direction.

2. Background Art

A support device for supporting an apparatus such as a camera and a television in any direction has been known, as described in the below-mentioned patent literatures No. 1 to No. 5.

Patent literature No. 1 discloses a universal joint fixing device for various video equipment wherein, on both end parts of a first cylinder, a second cylinder and a third cylinder which are separately rotatable around an axial direction of the first cylinder are provided, and turning of the second and third cylinders around the axial direction may be fixed separately.

Patent literatures No. 2 to No. 5 disclose support devices including a ball joint.

### CITATION LIST

### Patent Literature

1. Japanese Patent Publication No. 3234972

2. Japanese Registered Utility Model No. 3119171

3. Japanese Laid-Open Patent Publication No. H10-274235

4. Published Japanese Translations of PCT Patent Application No. 2002-500320

5. Published Japanese Translations of PCT Patent Application No. 2000-512716

### SUMMARY OF INVENTION

### Technical Problems

However, in the devices disclosed in patent literatures No. 2 to No. 5, there has been a case where an apparatus cannot be supported in a desired direction, since a rotation angle is limited due to the constructive properties of ball joint.

In the device disclosed in patent literature No. 1, there has been a case where mounting of an apparatus is not stable when the apparatus is turned in vertical/horizontal directions, because each of second and third cylinders rotates.

### Solution to Problems

In view of the above problems, the present invention aims to provide a support device which can easily turn an apparatus in any directions and stably fix it.

A support device according to the present invention includes an arm unit for turning an apparatus in a predetermined direction; a base for supporting the arm unit; a first supporting rod provided at one side of the arm unit to which the apparatus is attached at one end thereof; and a second supporting rod provided at the other side of the arm unit for connecting the arm unit and the base, and further includes first turning means for turning the arm unit in a vertical direction and fixing the arm unit at a predetermined position; and second turning means for turning the arm unit in a horizontal direction and fixing the arm unit at a predetermined position.

According to the above configuration, the arm unit can be turned in two directions i.e. vertical/horizontal directions separately. Therefore, the apparatus can be easily turned and stably fixed in any direction within a rotatable range of the arm unit.

In the support device according to the present invention, the first turning means may include a first engaging part formed at one end of the second supporting rod and a second engaging part formed at one end of the arm unit to engage with the first engaging part. And the second turning means may include a third engaging part formed at the other end of the second supporting rod and a fourth engaging part formed on the base to engage with the third engaging part.

In this case, it is preferable that the first engaging part is a gear part made up of a cylindrical member, the second engaging part is a storage part formed inside of the arm unit for storing the gear part, the third engaging part is a gear part made up of a disc member, and the fourth engaging part is a gear part formed on a top of the base.

With this configuration, the arm unit can be turned and fixed with simple structure, and thus it is possible to manufacture the device at low cost.

In the support device according to the invention, third turning means for turning the first supporting rod in a vertical direction and fixing the rod at a predetermined position may be provided.

With this configuration, each supporting rod provided at each end of the arm unit can turn with separate angle. Therefore, it is possible to expand the rotatable range of the apparatus attached to the end of the first supporting rod.

In this case, it is preferable that the third turning means includes a spherical part formed at the other end of the first supporting rod and a storage part formed inside of the arm unit for storing the spherical part.

With this configuration, the first supporting rod can be easily turned with simple structure.

In the support device according to the invention, adjusting means for adjusting horizontal turning or fixing of the arm unit by the second turning means may be provided.

With this configuration, it is possible to easily change the turning position of the arm unit in a horizontal direction.

In the support device according to the invention, the adjusting means may be made up of a rotary knob connected to the second supporting rod. The rotary knob may be mounted on an upper part of the base in an upward/downward movable manner. The second turning means may be allowed to turn or fix the arm unit by turning the rotary knob to be moved upward or downward.

In this manner, it is possible to easily change the turning position of the arm unit in a horizontal direction by turning the rotary knob. Also, it is possible to fix the second supporting rod to the base through the rotary knob, thereby the arm unit becomes stable and thus mounting of the apparatus can be also stable.

### ADVANTAGEOUS EFFECTS OF INVENTION

According to the present invention, the arm unit can be turned in two (vertical and horizontal) directions separately and thus the apparatus can be easily turned in any direction and stably fixed.

### BRIEF DESCRIPTION OF DRAWINGS

FIG. 1 is an external view of a support device according to an embodiment of the present invention;

FIG. 2 is an exploded view of an arm unit;

FIG. 3 is an exploded view of the arm unit;

FIG. 4 is a view showing a structure of a second gear part;

FIG. 5 is a view showing a structure of a rotary knob;

FIG. 6 is a view showing an assembled state of the arm unit;

FIG. 7 is a view showing a structure of a base;

FIG. 8 is a view showing a structure of the base; and

FIG. 9 is a view showing a state in which the arm unit is attached to the base.

### DESCRIPTION OF EMBODIMENTS

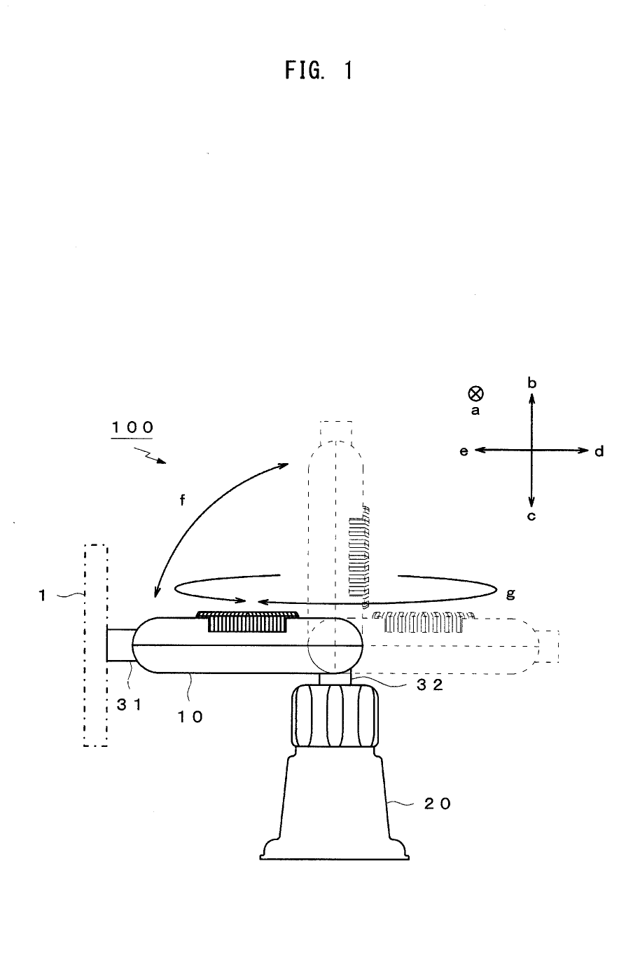

Hereinafter, an embodiment of the present invention will be described with reference to FIGS. 1-8.

In FIGS. 1-8, the same reference signs are applied to the same parts or corresponding parts.

FIG. 1 is an external view of a support device 100 according to an embodiment of the present invention.

In FIG. 1, the support device 100 is made up of an arm unit 10, a base 20, a first supporting rod 31 provided at one end of the arm unit 10 so as to protrude, and a second supporting rod 32 provided at the other end of the arm unit 10 so as to protrude which connects the arm unit 10 and the base 20. An apparatus 1 such as a camera, a flat-screen TV and a car navigation system device is attached to one end of the first supporting rod 31.

Reference signs “a” to “g” in the drawings indicate each direction. In FIG. 1, a direction “a” is a direction perpendicular to the page, “b” is a vertical upward direction and “c” is a vertical downward direction. A direction “d” is a horizontal right direction and “e” is a horizontal left direction. Directions “f” and “g” indicate the direction in which the arm unit 10 can turn.

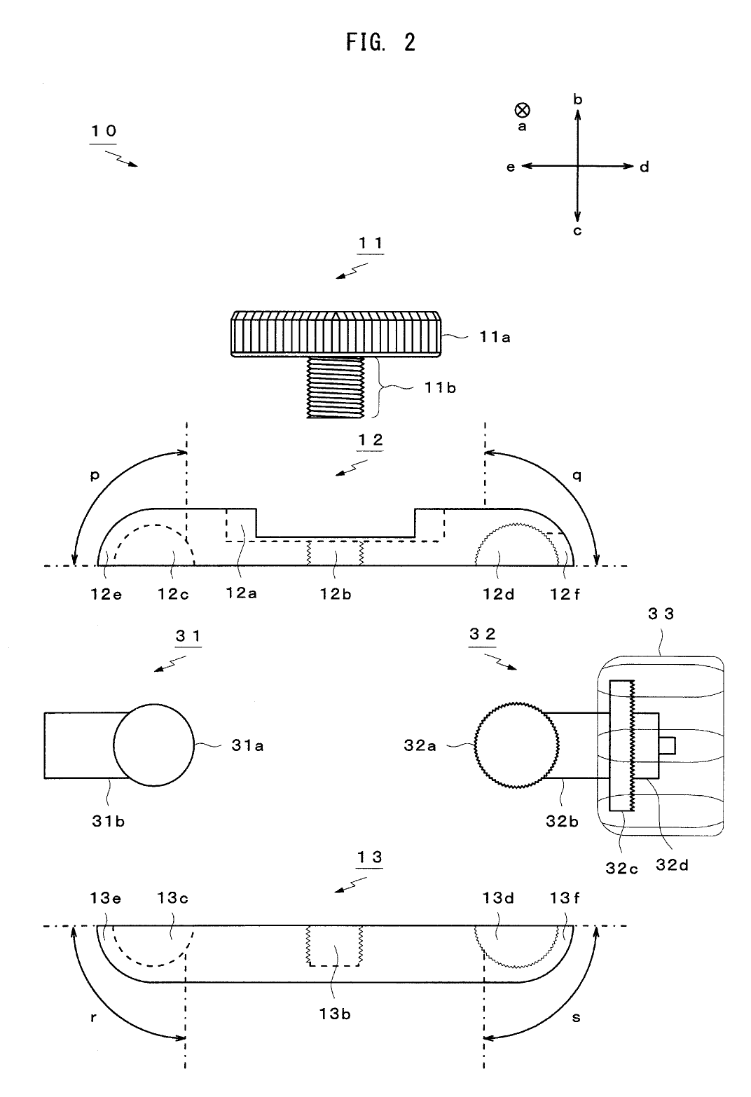

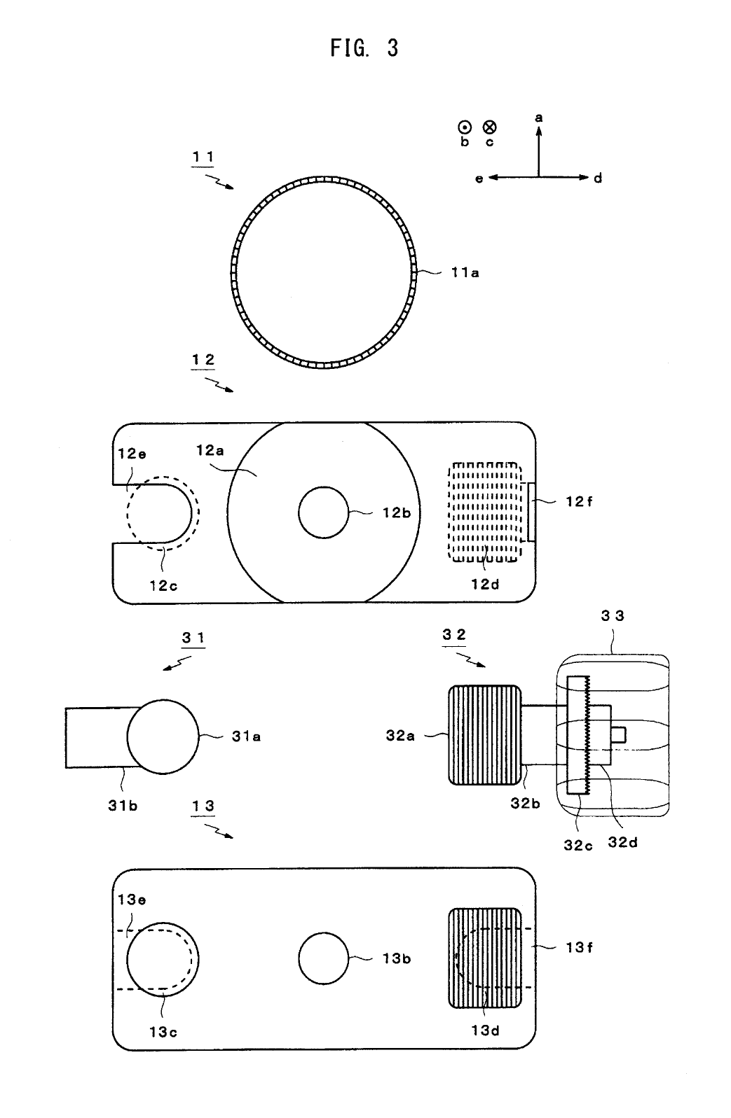

FIG. 2 is a view showing a structure of the arm unit 10 which is seen from side (the direction “a” in FIG. 1). Similarly, FIG. 3 is a view showing a structure of the arm unit 10 which is seen from top (the direction “c” in FIG. 1).

The arm unit 10 is made up of a tightening knob 11, a first frame 12, a second frame 13, the first supporting rod 31 and the second supporting rod 32.

The tightening knob 11 is made up of an operating part 11a for tightening operation and a thread part 11b (FIG. 2). The operating part 11a and the thread part 11b are roughly cylindrical in shape. On a side surface of the thread part 11b, a male thread is formed.

The first frame 12 includes a recess 12a, a hole 12b, a first storage part 12c, a second storage part 12d, a first guide groove 12e and a second guide groove 12f.

Specifically, the recess 12a has a size capable of storing the operating part 11a of the tightening knob 11 and is formed in the middle of a top surface of the first frame 12.

The hole 12b is formed at the center of the recess 12a. An inside surface of the hole 12b has a female thread into which the thread part 11b of the tightening knob 11 is screwed.

The first storage part 12c has a size and shape capable of storing closely an upper half part of a spherical part 31a formed at one end of the first supporting rod 31, and is formed at one end of the first frame 12.

The second storage part 12d has a size and shape capable of storing closely an upper half part of a cylindrical first gear part 32a formed at one end of the second supporting rod 32, and is formed at the other end of the first frame 12. On an inside surface of the second storage part 12d, gear-like projections for engaging the first gear part 32a are formed.

A first guide groove 12e is formed into a shape which allows a shaft part 31b of the first supporting rod 31 to turn within the range “p” in FIG. 2 (angle range from 0 to 90 degrees). That is, the first guide groove 12e is a notch formed at one end of the first frame 12, being slightly wider than the shaft part 31b of the first supporting rod 31 and open at its upper side.

A second guide groove 12f is formed into a shape which does not allow a shaft part 32b of the second supporting rod 32 to turn within the range “q” in FIG. 2 (angle range from 0 to 90 degrees). That is, the second guide groove 12f is a notch formed at the other end of the first frame 12, being slightly wider than a shaft part 32b of the second supporting rod 32, and not open at its upper side.

The second frame 13 includes a recess 13b, a third storage part 13c, a fourth storage part 13d, a third guide groove 13e and a fourth guide groove 13f.

Specifically, the recess 13b is formed at a position faced to the hole 12b formed in the first frame 12. An inside surface of the recess 13b has a female thread into which the thread part 11b of the tightening knob 11 is screwed.

The third storage part 13c has a size and shape capable of storing closely a lower half part of the spherical part 31a formed at one end of the first supporting rod 31, and is formed at one end of the second frame 13.

The fourth storage part 13d has a size and shape capable of storing closely a lower half part of the cylindrical first gear part 32a formed at one end of the second supporting rod 32, and is formed at the other end of the second frame 13. On an inside surface of the fourth storage part 13d, gear-like projections for engaging the first gear part 32a are formed.

A third guide groove 13e is formed into a shape which allows the shaft part 31b of the first supporting rod 31 to turn within the range “r” in FIG. 2 (angle range from 0 to 90 degrees). That is, the third guide groove 13e is a notch formed at one end of the second frame 13, being slightly wider than the shaft part 31b of the first supporting rod 31 and open at its lower side.

A fourth guide groove 13f is formed into a shape which allows the shaft part 32b of the second supporting rod 32 to turn within the range “s” in FIG. 2 (angle range from 0 to 90 degrees). That is, the fourth guide groove 13f is a notch formed at the other end of the second frame 13, being slightly wider than the shaft part 32b of the second supporting rod 32, and open at its lower side.

As described above, at one end of the second supporting rod 32, the first gear part 32a is formed. Also, at the other end of the second supporting rod 32, the disc-shaped second gear part 32c and the projection part 32d are formed.

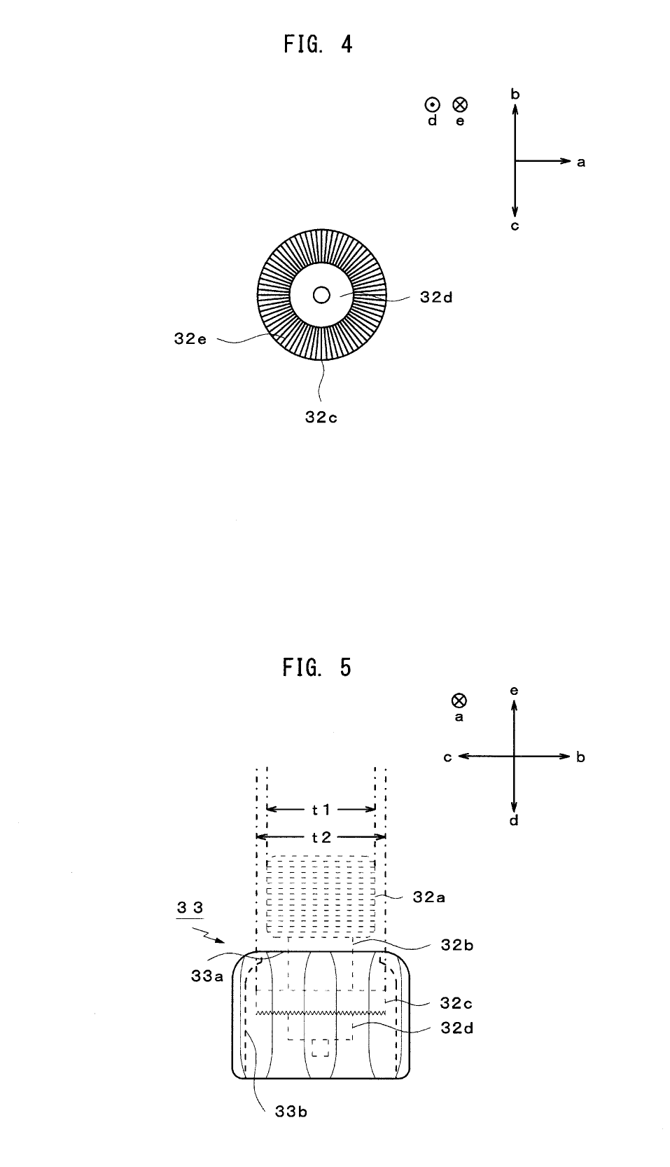

Specifically, as indicated in FIG. 4, radial gear-like projections 32e are formed on the second gear part 32c.

Also, a rotary knob 33 is attached to the second supporting rod 32.

Specifically, the rotary knob 33 is made up of a cylindrical member as indicated in FIG. 5. At a top surface of the rotary knob 33, a hole 33a is formed. A diameter of the hole 33a is larger than a width t1 of the first gear part 32a and smaller than a diameter t2 of the second gear part 32c. And an inside surface 33b has a female thread into which a below-mentioned thread part 20c (FIG. 7) formed on the base 20 is screwed. A lower surface of the knob 33 is open.

The first gear part 32a is one embodiment of the first engaging part of the first turning means in the present invention. The second storage part 12d and the fourth storage part 13d are one embodiment of the second engaging part of the first turning means in the present invention.

The second gear part 32c is one embodiment of the third engaging part of the second turning means in the present invention. The spherical part 31a, the first storage part 12c and the third storage part 13c are one embodiment of the third turning means in the present invention. The rotary knob 33 is one embodiment of adjusting means in the present invention.

When the first frame 12 and the second frame 13 having the above-mentioned structure are coupled together, the spherical part 31a formed at one end of the first supporting rod 31 are stored in the first and third storage part 12c and 13c, and the cylindrical first gear part 32a formed at one end of the second supporting rod 32 are stored in the second and fourth storage part 12d and 13d. Further, the shaft part 31b of the first supporting rod 31 is passed through the first guide groove 12e and the third guide groove 13e, and the shaft part 32b of the second supporting rod 32 is passed through the second guide groove 12f and the fourth guide groove 13f.

Then, the thread part 11b of the tightening knob 11 is screwed into the hole 12b and the recess 13b to join the first frame 12 and the second frame 13 closely.

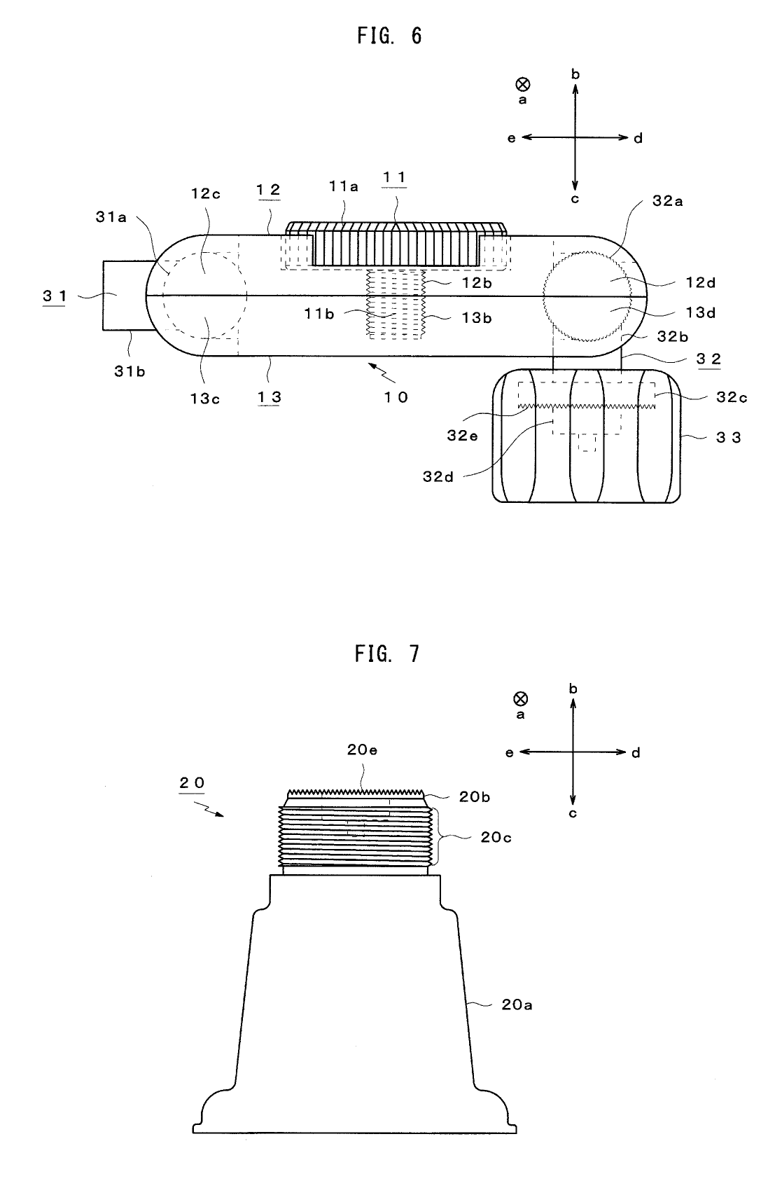

In this manner, the spherical part 31a is stored in the first and third storage part 12c and 13c closely and the first gear part 32a is stored in the second and fourth storage part 12d and 13d closely. Therefore, as indicated in FIG. 6, the first supporting rod 31 and the second supporting rod 32 are fixed at both ends of the first frame 12 and the second frame 13 respectively, and turning of each supporting rod 31 and 32 is regulated.

In the arm unit 10, when loosening the tightening knob 11, that is, when the thread part 11b is screwed out from the recess 13b by a certain amount by turning the operating part 11a, the spherical part 31a is released from the closely contact state in the first and third storage part 12c and 13c, and also the first gear part 32a is released from the closely contact state in the second and fourth storage part 12d and 13d. Therefore, the shaft part 31b of the first supporting rod 31 can turn within the range “p” and “r” in FIG. 2, and the shaft part 32b of the second supporting rod 32 can turn within the range “s” in FIG. 2.

Consequently, it is possible to fix the first supporting rod 31 and/or the second supporting rod 32 in any direction through the following process. First, the thread part 11b of the tightening knob 11 is screwed out from the recess 13b by a certain amount to loosen the contact state of the first frame 12 and the second frame 13. After that, the first supporting rod 31 and/or the second supporting rod 32 are turned in any direction. In this state, the thread part 11b of the tightening knob 11 is screwed in by a certain amount by turning the operating part 11a again to join the first frame 12 and the second frame 13 closely.

In addition, in the case where the thread part 11b of the tightening knob 11 is not screwed out entirely from the recess 13b, the first gear part 32a is kept being stored in the second and fourth storage part 12d and 13d. As a result, the rotary knob 33 is never detached from the arm unit 10.

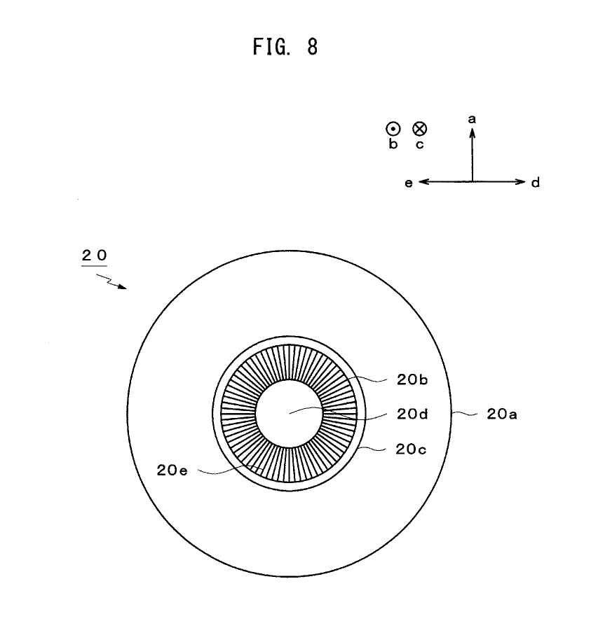

FIG. 7 is a view showing a structure of the base 20 which is seen from side (the direction “a” in FIG. 1). Similarly, FIG. 8 is a view showing a structure of the base 20 which is seen from top (the direction “c” in FIG. 1).

On a main body 20a of the base 20, a third gear part 20b, a thread part 20c and a hole 20d (FIG. 8) are formed.

Specifically, the third gear part 20b is formed on a top of the main body 20a and radial gear-like projections 20e are formed thereon as indicated in FIG. 8 for engaging the gear-like projections 32e (FIGS. 4 and 6) of the disc-shaped second gear part 32c formed at the other end of the second supporting rod 32.

The thread part 20c is formed on an upper side surface of the main body 20a and has a male thread screwed into the female thread formed on the inside surface 33b (FIG. 5) of the rotary knob 33.

The hole 20d is formed on a top surface of the main body 20a for the purpose of storing the projection part 32d formed at the other end of the second supporting rod 32, when the second gear part 32c formed at the other end of the second supporting rod 32 and the third gear part 20b are engaged.

The third gear part 20b is one embodiment of the fourth engaging part of the second turning means in the present invention.

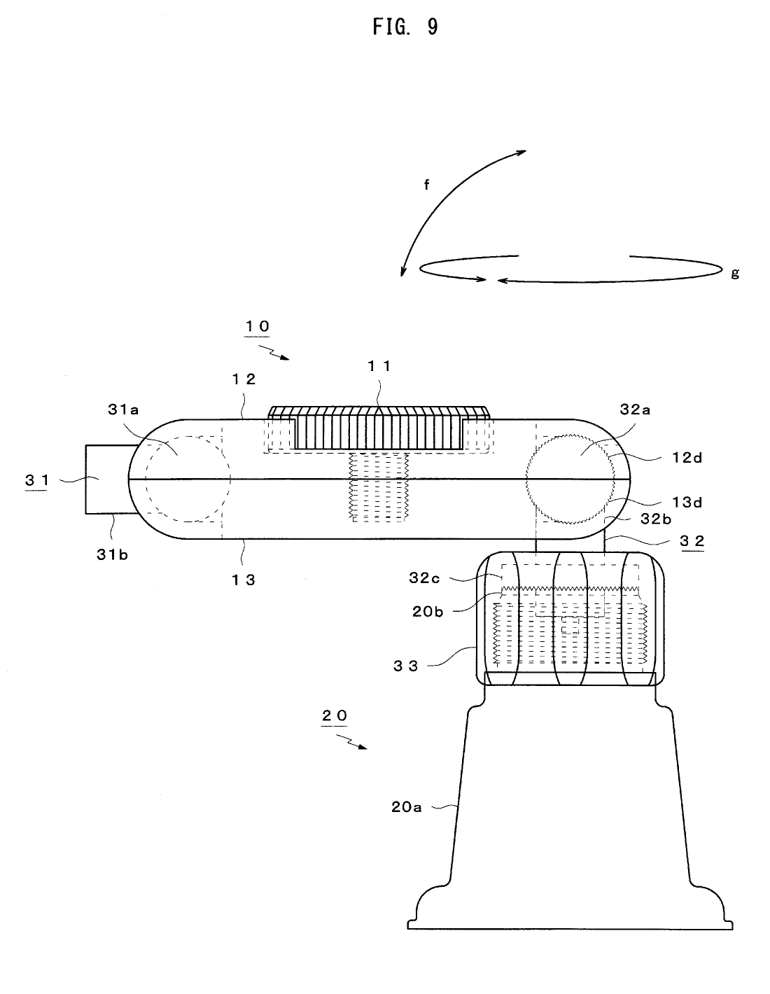

In the base 20 having the above-mentioned structure, the projection part 32d formed at the other end of the second supporting rod 32 is passed through the hole 20d formed on the base 20, and the second gear part 32c formed at the other end of the second supporting rod 32 and the third gear part 20b formed on the base 20 are engaged. Then, the rotary knob 33 is turned to completely screw the thread part 20c (a male thread) formed on the upper side surface of the main body 20a of the base 20 into the female thread formed on the inside surface 33b of the rotary knob 33. Thus, as indicated in FIG. 9, the rotary knob 33 is mounted on an upper part of the base 20 in an upward/downward movable manner, and the second supporting rod 32 is fixed to the base 20 through the rotary knob 33. In this state, since the second gear part 32c and the third gear part 20b are engaged by gear with each other, the second supporting rod 32 and the arm unit 10 coupled to the rod are not allowed to turn in the direction “g”.

When the rotary knob 33 is turned to be moved upward and screwed out from the thread part 20c by a certain amount, the second gear part 32c formed at the other end of the second supporting rod 32 and the third gear part 20b formed on the base 20 are disengaged. Therefore, the second supporting rod 32 and the arm unit 10 coupled to the rod are allowed to turn in the direction “g”.

Thus, in the embodiment described above, as indicated in FIG. 9, the first gear part 32a is formed at one end of the second supporting rod 32 and stored in the second and fourth storage part 12d and 13d having gear-like projections for engaging the gear part 32a. The tightening condition between the first frame 12 and the second frame 13 is adjusted by the tightening knob 11. If the tightening by the tightening knob 11 is firm, the arm unit 10 made up of the first and second frames 12 and 13 is fixed in a vertical direction to the base 20 (the directions “b” and “c” in FIG. 1) and is not allowed to turn in the direction “f”. On the other hand, if the tightening by the tightening knob 11 is loose, the arm unit 10 made up of the first and second frames 12 and 13 is allowed to turn within the angle range from 0 to 90 degrees in the direction “f” with the gear part 32a of the second supporting rod 32 as a center.

Further, the second gear part 32c is formed at the other end of the second supporting rod 32 and engaged with the third gear part 20b formed on the top of the main body 20a of the base 20. The tightening condition between the second gear part 32c and the third gear part 20b is adjusted by the rotary knob 33. If the tightening by the rotary knob 33 is firm, the second gear part 32c and the third gear part 20b are engaged. Therefore, the arm unit 10 made up of the first and second frames 12 and 13 is fixed in a horizontal direction to the base 20 (the directions “d” and “e” in FIG. 1) and is not allowed to turn in the direction “g”. On the other hand, if the tightening by the rotary knob 33 is loose, the second gear part 32c and the third gear part 20b are disengaged. Therefore, the arm unit 10 made up of the first and second frames 12 and 13 is allowed to turn within the angle range from 0 to 360 degrees in the direction “g” with the shaft part 32b of the second supporting rod 32 as a center.

Furthermore, since the spherical part 31a formed at one end of the first supporting rod 31 is allowed to turn in the direction “f” according to the tightening condition of the tightening knob 11, it is possible to further expand the turning range of the apparatus 1 (FIG. 1) attached to the other end of the first supporting rod 31.

Various embodiments other than those mentioned above can be employed in the present invention. For example, in the above embodiment, the cylindrical first gear part 32a is formed at one end of the second supporting rod 32. Alternatively, a spherical part similar to the spherical part 31a formed at one end of the first supporting rod 31 may be formed at one end of the second supporting rod 32, and convex projections may be formed on a surface of the spherical part. In this case, concave projections for engaging the convex projections should be formed on an inside surface of the second and fourth storage parts 12d and 13d.

Also, in the above embodiment, the second gear part 32c is formed at the other end of the second supporting rod 32 and the third gear part 20b for engaging the second gear part 32c is formed on the top of the main body 20a of the base 20. Alternatively, either the second gear part 32c or the third gear part 20b may be made up of a member having large friction coefficient (for example, a rubber-like member).

Also, in the above embodiment, the spherical part 31a is formed at one end of the first supporting rod 31. Alternatively, a gear part similar to the cylindrical first gear part 32a formed at one end of the second supporting rod 32 may be formed. In this case, gear-like projections for engaging the gear part should be formed on an inside surface of the first and third storage parts 12c and 13c.

Further, in the above embodiment, the base 20 is formed into a substantially cylindrical shape. Alternatively, the base 20 may be formed into a tripodal shape, etc.

### REFERENCE SIGNS LIST

1 apparatus
10 arm unit
11 tightening knob
12 first frame
12c first storage part
12d second storage part
13 second frame
13c third storage part
13d fourth storage part
20 base
20b third gear part
31 first supporting rod
31a spherical part
32 second supporting rod
32a first gear part
32c second gear part
33 rotary knob
100 support device

1. A support device, comprising:
an arm unit for turning an apparatus in a predetermined direction;
a base for supporting the arm unit;
a first supporting rod provided at one side of the arm unit to which the apparatus is attached at one end thereof; and
a second supporting rod provided at the other side of the arm unit for connecting the arm unit and the base, wherein the support device further comprises:
first turning means for turning the arm unit in a vertical direction and fixing the arm unit at a predetermined position; and
second turning means for turning the arm unit in a horizontal direction and fixing the arm unit at a predetermined position.

2. The support device according to claim 1, wherein
the first turning means includes a first engaging part formed at one end of the second supporting rod and a second engaging part formed at one end of the arm unit to engage with the first engaging part, and
the second turning means includes a third engaging part formed at the other end of the second supporting rod and a fourth engaging part formed on the base to engage with the third engaging part.

3. The support device according to claim 2, wherein
the first engaging part is a gear part made up of a cylindrical member, the second engaging part is a storage part formed inside of the arm unit for storing the gear part, the third engaging part is a gear part made up of a disc member, and the fourth engaging part is a gear part formed on a top of the base.

4. The support device according to claim 1 further comprising:
third turning means for turning the first supporting rod in a vertical direction and fixing the rod at a predetermined position.

5. The support device according to claim 4, wherein
the third turning means includes a spherical part formed at the other end of the first supporting rod and a storage part formed inside of the arm unit for storing the spherical part.

6. The support device according to claim 1 further comprising:
adjusting means for adjusting horizontal turning or fixing of the arm unit by the second turning means.

7. The support device according to claim 6, wherein
the adjusting means is made up of a rotary knob connected to the second supporting rod, the rotary knob is mounted on an upper part of the base in an upward/downward movable manner, and by turning the rotary knob to be moved upward or downward, the second turning means is allowed to turn or fix the arm unit.
